(19) United States
(12) Patent Application Publication
(10) Pub. No.: US 2021/0335113 A1
(43) Pub. Date: Oct. 28, 2021

(54) Equipment for Monitoring and Detecting the Presence of an Infant Inside a Motor Vehicle

(71) Applicant: Giuseppe GUIDA, Caserta (IT)

(72) Inventor: Giuseppe GUIDA, Caserta (IT)

(21) Appl. No.: 17/274,202

(22) PCT Filed: Aug. 8, 2019
(86) PCT No.: PCT/IB2019/056752

§ 371 Date: Mar. 8, 2021

(30) Foreign Application Priority Data
Sep. 10, 2018 (IT) 102018000008458

(51) Int. Cl. G08B 21/02; B60N 2/00; G07C 5/08; B60R 22/48; G08B 21/22; G08B 21/24

(52) U.S. Cl. CPC G08B 21/02; B60N 2/002; G07C 5/0808; B60N 2/26; G08B 21/22; G08B 21/24; B60R 2022/4816; B60R 22/48

(57) ABSTRACT

An assembly to detect the presence of a child inside the passenger compartment of a motor vehicle includes an identification element configured to be applicable on a predetermined location; a receiving element configured to detect the presence of the identification element; a control unit communicating with the receiving element and programmed for processing the information coming from the receiving element so as to emit an alarm signal as soon as a condition including the missing detection of the identification element occurs, and at the same time, occurs when at least a predetermined condition is present of the vehicle in which the assembly is installed in use.

### TECHNICAL FIELD

The present invention relates to the technical field of accessories for motor vehicles.

In particular, the invention relates to an innovative equipment enabling not to forget accidentally a child inside one's own car. The invention also includes the vehicle comprising this equipment.

### BRIEF OUTLINE OF THE PRIOR ART

Nowadays, unfortunately, it is common to hear of news concerning the death of children who were accidentally forgotten inside a car.

Unfortunately, as unlikely as it may seem, it can accidentally happen more frequently than one might think. In fact, hectic life and worries for work-related reasons can distract the person who transports the child on the car for example to the point of going to work forgetting the child in the car.

Obviously, the thing endangers the child's life especially in summertime when as the hours go by the car under the sun becomes a real oven with internal temperatures that can easily exceed 50° C.

For example, it has already happened that fathers exceptionally, in place of mothers, brought the child to the baby farm before going to work.

Evidently, the lack of habit in carrying out this operation, perhaps together with the problems and telephone calls for work-related reasons that occur even before entering the office, can contribute to a distraction such that the father goes directly to the workplace, without passing from the baby farm to leave the child and therefore dangerously parking the car in the parking lot under the sun. This can easily happen also because the child falls often asleep in the car on his child seat arranged on the rear seats. This contributes a lot to the risk of forgetting the child.

Unfortunately, in these situations, the parent became aware of what happened too late and even rushing to the car, the child was found dead by that time.

Being a real and concrete problem, various technical solutions have been presented in order to reduce the related risks and provide a support for avoiding to forget the child inside the car.

For example, the Italian patent number 0001408654 in the name of Luca Marano is known, which describes a system for detecting the presence of a child through the use of a weight sensor that detects the presence of the child arranged in his child seat inside the car and a sensor that detects the condition of engine on or off.

If the engine is off and the weight sensor detects the presence of the child on the child seat, then the alarm condition sets off.

Even functional, this system may be subject to some technical inconveniences.

For example, the installation of a weight sensor may become an inconvenience since it may alter the anatomy of the child seat, thus making the realization thereof more difficult.

Moreover, many weight sensors are less efficient for low weight values. Many children may even weigh less than four kilos and the sensor may not detect correctly the weight in these conditions.

Moreover, the sensor is integrated in the baby seat and therefore it is necessary to connect the baby seat to the power supply of the vehicle to make it work. The baby seat is often removed many times from the passenger compartment and therefore, it is necessary to disconnect and reconnect the power supply every time. In addition to being inconvenient, this operation is subject to the risk of forgetting to connect the power supply itself, thereby blocking the operation of the system.

Furthermore, the weight sensor may not work properly if the machine is parked on roads with a predetermined inclination and the sensor may also emit false alarms if the child is fidgety and is often moving.

It is known also the publication US2013/0194089 corresponding to the preamble of claim 1.

### SUMMARY OF THE INVENTION

Therefore, the aim of the present invention is to provide an assembly, which resolves at least in part said technical disadvantages.

In particular, the aim of the present invention is to provide an assembly, and relative method of operation, capable of detecting the presence of a subject, preferably a child, inside the passenger compartment of a motor vehicle in an effective manner and with a constructively simple solution, without needing the presence of weight sensors which may work in inaccurate manner in different situations.

These and other aims are therefore achieved with the present assembly to detect the presence of a subject, preferably a child, inside the passenger compartment of a motor vehicle, for example a car, according to claim 1.

This assembly comprises:

At least one identification element (5; 5′) configured to be applicable or applied onto a predetermined point of a surface on which in use the subject is sitting and in such a position that it is obscured by the said subject when the said subject is to be sat down or is sitting on said point;

At least one receiving element (6) suitable for detecting the presence of the identification element;

A control unit communicating with said receiving element and programmed for processing the information coming from said receiving element so as to control the emission of at least an alarm signal when a condition including the missing detection of the identification element occurs, contextually, occurring at least a predetermined condition of the vehicle on which the assembly is installed or it is installable in use.

Therefore, by arranging the identification element, for example a code, so that it is obscured when the subject, such as the child, regularly occupies his assigned seat, for example on the child seat, the acquisition of this identification element does not occur and gives a negative result since it is obscured by the subject sitting on it; the system, when it does not detect the identification element, is programmed for checking one condition or more operative conditions of the vehicle and, depending on the result, can emit an alarm.

In fact, the missed detection of the identification element indicates the possible presence of the child or a subject in general inside the vehicle on his assigned seat.

This solution, de facto, does not use commonly used weight sensors which may be misled by weights arranged erroneously or in any case may not work properly for the reasons described in the prior art.

Moreover, this solution is particularly simple.

When the child is on his seat, the covers the identification element (the code) by sitting down. Therefore, this identification element must be arranged on the seat intended for the child and in such a position as to be obscured by the child when he is sitting. For example, it could be arranged on the seat in correspondence of the plane of the bottom seat.

The device for acquiring images which does not find anymore the identification element, since it is obscured by the child, acquires this information which is passed to the processing unit which processes it as the presence of the child on board. At this point, the processing unit checks one or more working or operative conditions of the car (such as engine on or off) and in the event of predetermined combination of occurrences, emits one or a succession of alarms.

Advantageously, this identification element can be a code (5; 5′).

Advantageously, said code is selected from:

A unidimensional code, for example a barcode.

A bidimensional code, for example a QR-Code;

A code with more than two dimensions, such as a three-dimensional code.

Advantageously, for example, said code can be arranged on a support connectable in removable manner, for example by means of a layer made of Velcro.

Advantageously, said code could also be made by one or more parts assemblable with one another.

In any case, the identification element could be any symbol/image/drawing detected by the processing unit as a code of the safety subject of the invention.

Advantageously, irrespective of the shape and/or the type of identification element, said receiving element is a device for acquiring images, preferably a camera.

Advantageously, in this manner, the device for acquiring the image will be able to acquire the image of the identification element which obviously must be acquirable by a camera as an image.

In this manner, the system for generating the alarm is readily realized.

Advantageously, said identification element is arranged in such a position as to be obscured by the subject when in use the subject is sitting, preferably being arranged on a predetermined point of a child seat.

Advantageously, said predetermined working or operative conditions of the vehicle can comprise one or more of the following ones.

Engine on or off;

Open or closed car doors;

Windows wound up or down;

Fastened or unfastened security belts.

Advantageously, in a possible embodiment of the invention, said identification element (5; 5′) could be in the form of a source of light and said receiving element (6) could be a detecting device for detecting said emitted light.

It is also described here a method to detect the presence of a subject, preferably a child, inside the passenger compartment (2) of a motor vehicle (1), the method comprising the following steps:

Arrangement of at least one identification element (5) in a point of a child seat (10) or in an area (4) of the vehicle destined to the seat of the subject, said identification element being arranged so as to be obscured when the subject is regularly sitting on the seat or on said destined area;

At least one receiving element (6) installed on a predetermined point of the passenger compartment and suitable for detecting the presence of said identification element when it is not obscured when the subject is sitting on it; and

Providing an operation of control which generates an alarm as soon as a predetermined condition including the missed detection of the identification element by said device for acquiring images occurs, since it has been obscured by the subject and, contextually, at least a one predetermined operative condition of the vehicle occurs.

Advantageously, this receiving element is a device for acquiring images which can easily acquire the image of the identification element.

Advantageously, such operative conditions can be different. For example, in a not limiting manner, it is possible to mention:

Engine on or off;

Open or closed car doors;

Windows winded up or down;

Fastened or unfastened belts.

It is also described and claimed here a motor vehicle (1) comprising an assembly as described and operating according to the described method.

### BRIEF DESCRIPTION OF THE DRAWINGS

Additional features and advantages of the present assembly and relative method according to the invention will become apparent from the following description of preferred embodiments thereof, given only by way of non-limiting example, with reference to the attached drawings, wherein:

FIG. 1 schematizes a passenger compartment of a motor vehicle equipped with the present assembly according to the invention; for this purpose, the figure depicts a code 5 applied on a seat intended for a child and the cameras 6;

FIG. 2 schematizes the child seat equipped with this code 5 and the camera 6;

FIG. 3 is a flow chart which explains the operation.

### DESCRIPTION OF SOME PREFERRED EMBODIMENTS

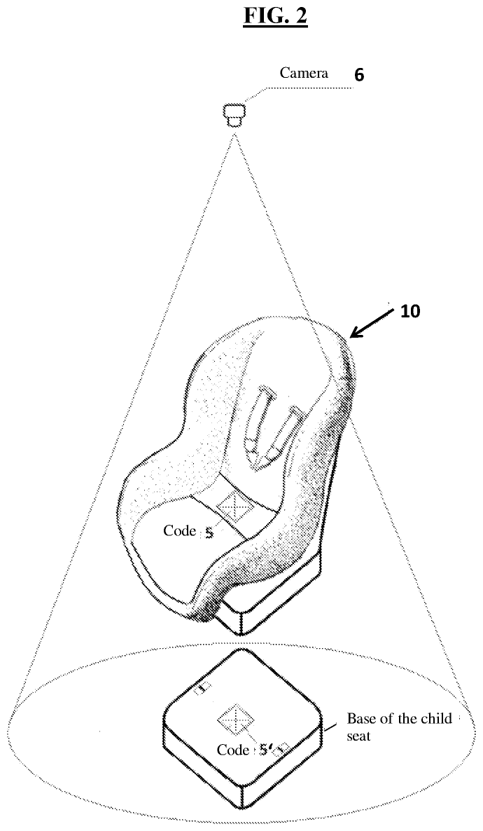

FIG. 2 schematizes a child seat 10 available on the market, which is configured for being applied on both rear and front car seats.

The child seat per se is known art and it is not the specific subject of the present invention; for this reason, it is not described structurally in detail here.

Therefore, according to the invention, it is provided a code 5 which is applied on the child seat, for example on the bottom seat, that is the part where the child's buttocks lean (see FIG. 2).

The code 5 can be for example printed directly on the child seat or, alternatively, it can be arranged on a layer which is applied in removable manner onto the child seat. For example, in a possible embodiment of the invention, the support on which it is obtained, could be provided with Velcro so as to be applied in removable manner on the bottom seat or anyway on the area providing the possibility to arrange it and providing the bottom seat for the child. Alternatively, the code could be arranged on a removable matt applicable onto the bottom seat.

Many types of codes can exist.

For example, a QR_CODE or a different type of code can be provided, for example a barcode.

Obviously, being understood what has been previously described, the code could also be applied (in permanent or removable manner) on other parts of the child seat. For example, it could be applied on the inner part of the shell where the belts holding the child to the child seat are fastened. In this way, when the belts are unfastened, the shell tips over ahead and the code is visible to the camera (condition with unfastened belts in which the child should not be on the child seat).

As mentioned, irrelevant from the type of code, it can be applied through sewing or Velcro or fixed in different ways or be integral to the child seat.

Advantageously, in a possible embodiment of the invention, the code to be applied to the child seat can be made up of two or more pieces, so as not to be read by the system by mistake if detached from the provided housing and accidentally replaced in a different position. In fact, being constituted by two pieces, it is probable that only a part moves accidentally thus leaving the incomplete code which is not read.

According to the invention, this code is then associated with one or more cameras 6 which are suitably arranged on predetermined points of the passenger compartment, so as to frame the code arranged on the child seat.

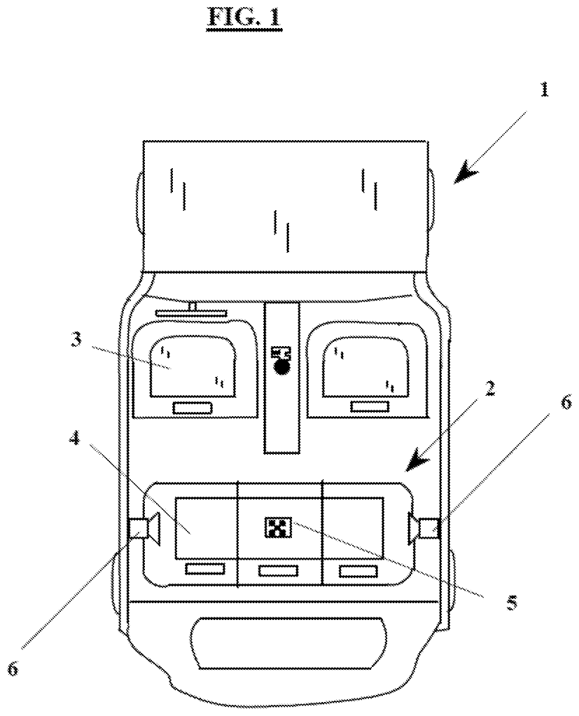

For example, FIG. 1 schematizes the passenger compartment of a car.

The car, well known in the state of the art and not subject of the present invention, includes the front seats 3 comprising the driving seat and the rear seats 4.

FIG. 1 depicts the code 5 arranged on the rear seat which, as said, is applied on a removable child seat to be fastened either to the rear or front seat in the preferred embodiment of the invention.

FIG. 1 schematizes the cameras 6 suitable for acquiring images and arranged on points of non-limiting example.

Two cameras can be arranged laterally to the two sides of the passenger compartment as per FIG. 1 and a further central camera and each camera destined for framing a potential code arranged on the relative seat under the camera.

Cameras can also be mobile, that is they can rotate around the fastening fulcrum thereof, so as to check within a certain range of action.

Therefore, the code can be any images that can be shot by the camera.

Possibly, in a possible embodiment of the invention, the code could be in the form of a specific source of light which emits a luminescence for example according to a predetermined drawing and/or according to a predetermined frequency or according to a sequence of light pulses. In this case, the camera is arranged in a system suitable to detect this source of light.

The source of light can be readily created through a series of lights arranged according to the predetermined drawing and which emit this luminescence from the child seat.

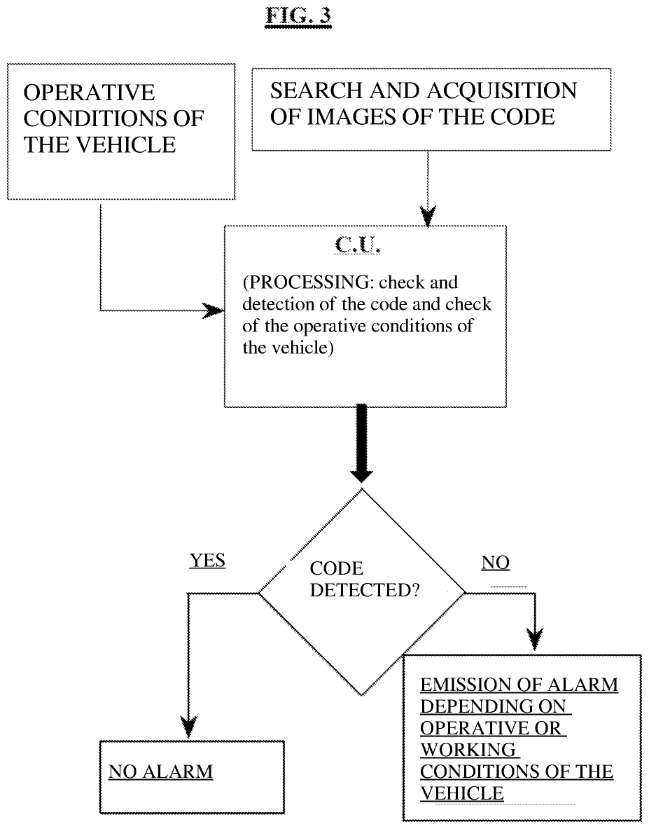

Finally, the system includes a central processing unit (depicted in FIG. 3 with the wording C.U.) which processes the data received from the camera so as to interpret such data suitably and generate a possible alarm condition if the result of the analysis of the data is such that the child is forgotten on the child seat of the car or anyway inside the car.

The central processing unit, suitably fitted with a suitable processor for processing data according to a specific programming, can be a separate unit, suitably installed on the vehicle, or can be constituted by the control unit already generally in use in modern cars and suitably programmed for this function.

The system of operation is as follows:

Solution with the Code Applied or Integrated to the Child Seat and Cameras (See for Example the Diagram of FIG. 3):

The cameras act for acquiring images and are arranged in the passenger compartment so as to frame the code 5 (for example a QR_Code or another code) which is arranged on a part of the child seat.

Therefore, it is provided a positioning of the child seat and/or an arrangement of the cameras such that they can always frame the code.

As said, the code is arranged in such a position as to be obscured and therefore not visible by the cameras when the child is regularly arranged onto the child seat, preferably with fastened safety belt.

When the system is activated, the cameras begin to search for the code. The images acquired are transmitted to the central processing unit which processes them to interpret the condition in progress.

When the control unit detects that the cameras are framing the code, (therefore the images contain the code), this information is interpreted by the system as an indicative information of the fact that the child is not present on the child seat and therefore there is no danger condition. Therefore, the system does not activate (or potentially deactivates) the alarm. In fact, if the code is visible, it means that it is not obscured by the child regularly arranged onto the child seat.

When the control unit, which interprets the images which are gradually acquired, detects the condition of code not found, the control unit interprets such information as the presence of the child on the bottom seat inside the passenger compartment and therefore checks other conditions of operation of the vehicle.

The condition of missed visualization of the code is interpreted as the child certainly sitting on the child seat (except for a possible false condition when an object is arranged by mistake onto the child seat thus covering the code).

In fact, when the child is sitting on the child seat, the code, as arranged on the child seat, is no more visible either because it is arranged on the bottom seat and therefore covered by the child or because it is arranged on other points which do not make it visible when the child is regularly sitting on the child seat with fastened safety belts.

Therefore, the information relative to the “missed visualization of the code” is interpreted by the control unit as a condition of potential risk as it indicates the fact that the child is on his place on the child seat and therefore at risk of being forgotten.

At this point the control unit checks some conditions of operation of the vehicle, which, depending on the occurrence thereof, can be interpreted as a condition to emit an alarm.

For example, the system can detect conditions such as:

Engine on or off:

Open or closed car doors;

Windows winded up or down.

The conditions above are not limiting and also different conditions may be used.

With the purpose of a not limiting example only, we suppose that the control unit has the following conditions:

Code not visible;

Engine on.

In this case the two conditions:

Code not visible=True;

Engine on=True.

They indicate that the child is sitting on the child seat, but the engine, being on, suggests that an adult is driving the vehicle and this condition is normal. Therefore, no alarm is emitted.

On the contrary, the condition:

Code not visible=True;

Engine on=False (therefore engine off).

It determines a condition of risk since the child is present on the child seat but the motor vehicle is stationary with engine off. In this case, the system sets to an alarm condition.

Obviously, the system may be freely programmed according to different levels of safety, thus integrating for example a further check of open or closed doors.

In this sense, the person skilled in the art can freely select the conditions of checking the different states of the vehicle, without however exceeding the inventive scope of the present invention.

Therefore, there may be different levels of signalling.

For example, a first level could be provided in which, at the moment when the condition of engine off and code not visible occurs, a sound and/or visual signal starts immediately. The signalling can start also at the moment of the effective opening of the door on the driver's side once the condition of engine off occurs. In this way, the driver which turned the car off and is about to leave the passenger compartment has immediately the indication of the presence of the child on the child seat.

If the child is removed from the child seat, the cameras detect again the code and therefore the central unit resets the alarm when:

Engine on=False,

Code not visible=False.

In the event that, despite the first level of alarm, the cameras are not able to detect the code, then after a predetermined time (a minute, for example), the central unit can activate the second level of signalling which can include the automatic sending of a SMS or a call to one or more memorized numbers.

Finally, a third level of safety can be provided, in which after a predetermined time from the sending of SMS and if the cameras have not found the code yet, a real sound alarm starts from the car with a possible emergency call to the police and, for example, wind down automatically the windows in order to make air circulate.

For example, an emergency system can be provided, such as the known eCall system which will be shortly compulsory on future cars.

Obviously, in all the described embodiments, the video detecting system can visualize real-time on the display of the car the images of the child sitting on the child seat, so as to monitor him for the whole drive, if necessary.

Therefore, the code can be any images framed by the camera and then processed in order to be recognized by the processing central unit.

The solution of the present invention is advantageous also because it is suitable for operating through the realization of a removable mat with the code on it, which can readily be applied to the bottom seat of the child seat. In this manner, by simply buying this mat and the rest of the system described, it is possible to use a pre-existing child seat without the need of buying a new and suitable child seat, like the systems with weight sensors.

Solution with Luminous Code and System for Acquiring Light:

Being understood what has been described heretofore, it is evident that the code could also be in the form of a predetermined source of light and, instead of cameras, systems for acquiring the source of light can be provided which are always processed by the central unit.

Obviously, the principle of operation does not change and the chart of FIG. 3 is equally valid.

The type of child seat is generally removable. In order to avoid to set off an alarm when the child seat is removed, many solutions applicable to all the described embodiments can exist.

In a possible solution, it is possible to deactivate the alarm system described (for example through a suitable remote control).

Alternatively, a fixed support connected to the seat of the car can be provided and on which the child seat is arranged. In this case, this support can suitably be provided with the same code (see for this purpose the support with the code 5′ in FIG. 2) present on the child seat so that the code is always visible after removing the child seat, thus avoiding to set off the alarm.

An alternative code to the first one can possibly be provided on the fixed support, thus also enabling to distinguish whether the detected code is of the base or of the seat, also useful in the case of several bases and/or several seats installed.

In fact, the described system can always be in operation, using a special battery or the car battery. In this way, it searches and detects the code continuously operating 24 h. Obviously, alternatively, it can be provided an operation with activation/deactivation by remote control at the user's discretion, or even an activation following the occurrence of certain pre-established conditions.

The control unit, as mentioned, can be in the form of a suitable processor, but the use of the control unit of the vehicle itself with a suitable programming can be also provided.

As mentioned, the application of the code, in any form, preferably takes place on the bottom seat. However, an application on other parts can also be provided, such as for example the inner part of the shell where the safety belts are fastened.

The integrated or separable code can be connected in any way or, as mentioned, it can even be in the form of a source of light.

The system for acquiring images can also transfer images directly to the display of the car so that the driver can monitor the child throughout the drive. Well-known infrared technologies can be used to acquire images even in a dark environment, for example at night.

The described system can obviously be integrated in the car but it can also be produced as a separate accessory and then installed in any cars.

The described system can also easily interface with current mobile phones, enabling the display directly on the mobile phone and/or the control (for example stopping the alarm) directly from the mobile phone.

In a further embodiment, the invention could be carried out in a particularly compact way, for example by using CAMs of reduced dimensions commonly available on the market.

In this case, it is possible to provide a battery inside the device.

The system could be permanently connected to the 12V cigarette lighter or 5V USB socket. The cigarette lighter and USB sockets of modern cars are usually powered when the ignition of the car is on, therefore when the ignition of the car is turned off, the power to the sockets stops. This condition is interpreted by the device as a signal to start searching for the code.

If the system finds the code, it will be deactivated until the ignition is switched on again. If it does not find the code, then the built-in buzzer is immediately activated, for example, on the cigarette lighter plug or on the camera itself, at the same time it also activates a suitable signaling light, perhaps red, or other means of visual signaling.

The device for visual signaling (lights) can be integrated into the cigarette lighter plug or it can be connected to it by cable and arranged in a position which is more easily visible to the driver.

The mobile device can have a sim module and an integrated GPS or an alternative navigation module, so that if by chance the child is not removed from the seat within a certain time, or the alarm is not stopped by a suitable reset button, at that point calls and text messages with the coordinates of the car are sent to memorized numbers.

A device can be installed for each seat or one or more cameras can be added to the basic device.

Another possible embodiment could also be that of first detecting the operating conditions of the car to start the signals and use the system for code detection to deactivate them in the event of actual detection.

For example, a simple electronic or electromechanical circuit could independently detect the condition of engine off and emit the suitable acoustic and light signals.

In this configuration the alarm system would therefore be independent of the code detection system; in fact, in the same way, the camera and the processor thereof could search for the code only when the car is actually switched off, and would have the purpose of disabling the function of circuit alarm once the actual detection of the code has been confirmed.

Otherwise, even in the event of a hypothetical breakage of the processor or camera, signals would anyway be emitted.

The present invention, although preferably addressed to protect children, can obviously also be used for any subjects, persons or animals, for example disabled persons.

The invention claimed is:

1. An assembly to detect a presence of a subject inside a passenger compartment of a vehicle, the assembly comprising:
an identification element configured to be applicable in a predetermined location;
a receiving element configured to detect a presence of the identification element; and
a control unit programmed to process information coming from said receiving element so that an alarm signal can be emitted as soon as a condition including a missing detection of the identification element occurs, and at the same time, a predetermined condition of the vehicle occurs in which the assembly is installed in use;
wherein said receiving element is a device configured to acquire images and arranged so as to acquire an image of said identification element.

2. The assembly, according to claim 1, wherein said identification element is a code.

3. The assembly, according to claim 2, wherein said code is any image detectable from said device configured to acquire images.

4. The assembly, according to claim 2, wherein said code is selected from the group consisting of:
a uni-dimensional code,
a bi-dimensional code, and
a code with more than two dimensions.

5. The assembly, according to claim 2, wherein said code is arranged onto a support connectable in removable manner.

6. The assembly, according to claim 2, wherein said code is made by one or more parts assemblable with one another.

7. The assembly, according to claim 1, wherein said device configured to acquire images is a camera.

8. The assembly, according to claim 1, wherein said identification element is arranged so as to be obscured by the subject when the subject is sitting.

9. The assembly, according to claim 1, wherein said predetermined condition is a working or operative condition of the vehicle selected from the group consisting of:
engine on or off;
open or closed car doors;
windows wound up or down; and
fastened or unfastened belts.

10. A method to detect a presence of a subject inside a passenger compartment of a vehicle, the method comprising the following steps:
arranging an identification element at a location of a seat of the subject or in an area of the vehicle receiving the seat of the subject, said identification element being arranged so as to be obscured when the subject is sitting on the seat or in said area;
providing a device configured to acquire images installed in a predetermined location of the passenger compartment and configured to frame said identification element when said identification element is not obscured when the subject is sitting in the seat; and
operating a control, which generates an alarm as soon as a predetermined condition including a missed detection of the identification element by said device configured to acquire images occurs, said identification element having been covered by the subject, and, contextually, when a predetermined operative condition of the vehicle occurs.

11. The method, according to claim 10, wherein said device configured to acquire images is a camera.

12. The method, according to claim 10, wherein said identification element is a code.

13. The method, according to claim 12, wherein said code is any image detectable from said device configured to acquire images.

14. The method, according to claim 12, wherein said code is selected from the group consisting of:
a unidimensional code,
a bidimensional code, and
a code with more than two dimensions.

15. (canceled)
